(19) United States
(12) Patent Application Publication
(10) Pub. No.: US 2020/0309574 A1
(43) Pub. Date: Oct. 1, 2020

(54) DISPLACEMENT SENSOR OPERATING WITHOUT CONTACT

(71) Applicant: Micro-Epsilon Messtechnik GmbH & Co. KG, Ortenburg (DE)

(72) Inventors: Thomas WISSPEINTNER, Ortenburg (DE); Harald HAAS, Ruhstorf a.d. Rott (DE); Tobias SCHOPF, Triftern (DE); Reinhold HOENICKA, Ortenburg (DE)

(21) Appl. No.: 16/650,751

(22) PCT Filed: Sep. 26, 2018
(86) PCT No.: PCT/DE2018/200088

§ 371 Date: Apr. 2, 2020

(30) Foreign Application Priority Data
Sep. 29, 2017 (DE) 10 2017 217 494.3

(51) Int. Cl. G01D 11/24; G01D 5/20; G01D 5/24

(52) U.S. Cl. CPC G01D 11/245; G01D 5/24; G01D 5/20

(57) ABSTRACT

With regard to reliable measurements in the high temperature range with constructionally simple means, the invention relates to a displacement sensor operating without contact having a sensor element (1) suitable for high temperatures and electronics comprising drive and/or evaluation electronics that are coupled electrically to the sensor element (1), which displacement sensor is characterized in that the electronics are designed for a temperature range above 125° C. and are connected directly to the sensor element (1) or integrated in the sensor element (1).

### CROSS REFERENCE TO RELATED APPLICATIONS

This application is a national stage application, filed under 35 U.S.C. § 371, of International Application No. PCT/DE2018/200088, filed Sep. 26, 2018, which claims priority to German Application No. 10 2017 217 494.3, filed Sep. 29, 2017; the contents of both of which as are hereby incorporated by reference in their entireties.

### BACKGROUND

### Technical Field

The invention relates to a contactlessly operating displacement sensor having a sensor element which is suitable for high temperatures and electronics which are electrically coupled to the sensor element and comprise control and/or evaluation electronics.

### Description of Related Art

Contactlessly operating displacement sensors, such as displacement sensors with integrated electronics for temperatures in the range of −40° C. to at most 125° C., for example, are widely known from practice. At higher temperatures, the electronics are usually disposed away from the sensor element or separately, so that they are removed from the high temperature region. In the range up to 125° C., conventional CMOS electronics in standard designs can be used.

At this point it must be emphasized that the present invention is a displacement sensor that can operate in the so-called high temperature range above 125° C. The term displacement sensor includes sensors that are suitable for displacement measurement, position measurement, distance measurement, thickness measurement, etc.

A contactlessly operating displacement sensor of the type mentioned above, which is suitable for the high temperature range, is known from WO 2014/114279 A1. In the sensor described there, a high temperature-suitable sensor element is surrounded by a special compensation element and a housing. The electronics are separated from the sensor element and electrically coupled to the sensor element via a high temperature resistant steel sheathed cable with mineral insulation.

The problem with the well-known contactlessly operating displacement sensor formed by an eddy current sensor is that the two contact points of the cable connection (one on the sensor element and one on the electronics) entail a number of disadvantages. These disadvantages are discussed in the following:

Since the cable in the known displacement sensor is part of the measurement chain due to the fact that the sensor element and the electronics are connected via the cable, the very small and high-frequency signals that occur during operation of the displacement sensor have to be transmitted via the cable and the contact points. Since the cable on the side of the sensor element is inevitably within the high temperature region as well, special cables are needed, e.g. Teflon cables with copper or steel strands, cables with a glass fabric sheath or mineral-insulated steel sheath cables. These types of cable are very difficult to handle, because the strands or the sheath made of stainless steel can be securely connected to the sensor housing or sensor element only by means of complex welding. Teflon cables are moreover difficult to seal, because sealing compounds or adhesives do not adhere to Teflon at all or only with difficulty.

There are also metrological disadvantages, because the cable (as part of the measurement chain) causes parasitic impedances (capacitances, resistances, inductances), which can affect the measuring result when the cable changes, e.g. due to temperature, movement or EMC radiation. High temperature-suitable cables often have a low insulation resistance, or restrict the frequency range because high carrier frequencies are not possible. Since the sensor element is in the high temperature region, but the electronics are in the normal temperature region, there is a temperature gradient along the cable which is difficult to compensate.

Furthermore, for metrological applications, the use of coaxial or even triaxial cables with the abovementioned properties is often necessary, which places high demands on the structural-design and connection technology. In addition, the installation space is inevitably very large due to the complex cable contacting required. Lastly, the error susceptibility increases, due to the difficult sealing of the contact point on the cable or on a connector or due to interference on the signal line.

High temperature-suitable displacement sensors are used in a variety of fields. Examples are oil and gas production, in which vibrations, high pressures and high temperatures can occur; the monitoring of turbines, e.g. power units, superchargers, steam turbines or gas turbines; heat engines or processing systems such as CVD systems; applications around radioactive radiation and astronautics.

### BRIEF SUMMARY

The underlying object of the present invention is therefore to configure and further develop a contactlessly operating displacement sensor of the abovementioned type in such a way that reliable measurements in the high temperature range are made possible with constructionally simple means.

According to the invention, the aforesaid object is achieved by a sensor having the features of claim 1. The sensor is accordingly configured and further developed such that the electronics are designed for a temperature range above 125° C. and are directly connected to the sensor element or integrated into the sensor element.

In the manner according to the invention, it has been recognized that, even in the high temperature range above 125° C., it is possible to carry out an electrical coupling between the sensor element and the electronics without the familiar cables, via which the electronics can be separated from the sensor element that is exposed to the high temperatures in the usual way. Specifically, electronics designed for this high temperature range are connected directly to the sensor element or integrated into the sensor element. The high temperature-suitable electronics are mounted quasi directly on the sensor element without requiring the use of any type of cable connection for the electrical coupling between the sensor element and the electronics. This ensures a high degree of measurement reliability, because interference from the cable during the transmission of the determined very small and/or high-frequency signals can be avoided. The production is furthermore simplified considerably as well, because there is no need to use special cables that are difficult to handle, and there is also no need to provide a large installation space for complex cable contacting.

As a result, the displacement sensor according to the invention is a displacement sensor which allows reliable measurements in the high temperature range with constructionally simple means.

With respect to a particularly high suitability for the high temperature range, the electronics, or at least one component of the electronics, can be produced on the basis of SoI (silicon on insulator) technology or on the basis of GaAs, SiC or diamond as the semiconductor material. SoI technology is suitable up to working temperatures of about 300° C. GaAs, SiC or diamond as semiconductor materials are also suitable for working temperatures above 300° C.

The high temperature sensor elements used within the context of the invention, which are used to measure geometric variables such as distance, position, displacement, thickness or vibration and, on the basis of these applications, can be referred to as displacement sensor elements, are based on electromagnetic measurement principles, i.e. an inductive, capacitive or eddy-current based mode of operation. Because of these measurement principles, these sensor elements are particularly suitable for high temperature applications.

In a constructionally particularly simple manner, the sensor element can comprise a substrate with at least one embedded sensor component, such as the windings of a coil. At least one strip conductor which can be used for contacting the electronics is advantageously disposed on the substrate.

The substrate should itself be suitable for the high temperature range, whereby the substrate can advantageously comprise a circuit board, preferably made of polyimide, PTFE (polytetrafluoroethylene) or LCP (liquid crystal polymer), or a ceramic, preferably made of AL₂O₃, LTCC (low temperature co-fired ceramics) or HTCC (high temperature co-fired ceramics). Such high temperature circuit boards are suitable up to a temperature of about 300° C. For temperatures higher than that, substrates made of ceramic are particularly advantageous. In principle, it is possible to realize a ceramic sensor element for the high-frequency range.

The electronics of the displacement sensor can be mounted directly on the sensor element. High temperature-suitable methods can be used for the necessary assembly and connection techniques. The electronics can advantageously be disposed in a ceramic housing, for example, or comprise at least one component disposed in a ceramic housing. Components of the electronics or electronic modules can be disposed in a ceramic housing. Alternatively, the electronics can be connected to the sensor element as a chip on board or chip on ceramic or as a flip chip on a silicon carrier. Semiconductor components (dies) can be directly connected to the sensor element by means of aluminum or gold wire bonds with bond pads on a substrate. The strip conductors already mentioned above, which can be disposed directly on the substrate, can be used for this purpose. In the case of a circuit board as a substrate, copper strip conductors specifically can be used. For LTCC or HTCC technology, printed circuits or strip conductors can be used.

The control electronics can particularly advantageously comprise an oscillator. With such an oscillator, the frequency required for the operation of the displacement sensor can be generated on site at the sensor element. There is therefore no need to transmit a high-frequency control signal to the electronics from a remote position via a line. The oscillator can be a sine wave oscillator, for example, or a square wave oscillator, whereby such a square wave oscillator is particularly easy to realize.

The evaluation electronics can generally consist of a plurality of functional assemblies. As a functional assembly, the evaluation electronics can particularly preferably comprise only a demodulator for generating a rectified voltage or current signal. This represents a very simple design of the evaluation electronics. With such a configuration, there is no need to transmit a high-frequency signal via a connecting line that is susceptible to a variety of interference factors. The evaluation electronics can further advantageously additionally comprise a preamplifier, because in this case preamplified signals that are less susceptible to external interference can be transmitted at a higher level. As an alternative or in addition to such a preamplifier, the evaluation electronics can comprise an analog-to-digital converter with which determined signals can already be digitized, which makes signal transmission particularly immune to interference. As a further alternative or addition to a preamplifier and/or an analog-to-digital converter, the evaluation electronics can also comprise a microcontroller which already performs signal processing, e.g. linearization, filtering, etc. Particularly advantageous for configuring the evaluation electronics is that nowadays there are also microcontrollers for temperature ranges up to 200° C.

The components of the electronics can be produced in SoI or GaAs processes, for example.

The electronics can particularly advantageously consist of logic components or comprise logic components, e.g. XOR gates, because logic components are also available in a very inexpensive high temperature version. Very simple oscillator and demodulator circuits can thus be realized.

Since the electronics are connected directly to the sensor element or integrated into the sensor element, simple and inexpensive cables can be used for power supply and for data transmission from the displacement sensor to peripheral devices and vice versa, because no high-frequency signals or low-level signals have to be transmitted. A supply voltage suffices for the control. The electronics on or in the sensor element can provide an already demodulated signal, for which no special demands are placed on the line. Standard high temperature lines or steel sheathed cables can therefore be used for output and/or supply, e.g. with twisted lines. In the most simple case, one pair of wires (e.g. twisted pair) suffices, if the signal is modulated onto the supply line in digital form or is provided in analog form via a current interface. If the supply and signal lines are implemented separately, two pairs of wires, e.g. 2×2 twisted pair, suffice. These are less expensive and easier to handle than coaxial or triaxial lines. The connecting line can be guided through a housing and connected to the electronics in a known manner. For this purpose, the electronics can comprise a suitable cable connection.

Since chemical processes are accelerated at high temperatures, hermetic sealing of the displacement sensor or components of the displacement sensor is particularly advantageous. Specifically, the displacement sensor or the sensor element and/or the electronics can be hermetically sealed. There are two aspects to hermetic sealing: On the one hand, it prevents harmful substances from penetrating into the displacement sensor or the sensor element and/or the electronics and attacking the electronic components or the supply lines or contacts there. On the other hand, hermetic sealing prevents outgassing or leaking of substances that could cause contamination or damage at the installation location of the displacement sensor. Such hermetic sealing is necessary for certain applications, such as processing systems or astronautics.

It is particularly advantageous if a hollow space in the displacement sensor, the sensor element or the electronics is filled with a preferably dry inert gas or evacuated during hermetic sealing.

Hermetic sealing can be achieved in several different ways. Hermetic sealing can be achieved in a particularly simple manner with a housing, preferably a housing that is soldered to the substrate, in particularly all the way around, and is thus hermetically sealed to the substrate. A metal housing can be soldered hermetically to a ceramic substrate, for example, e.g. by active soldering or by laser welding with a metal ring previously soldered on by vacuum soldering. Such a metal housing advantageously provides shielding against the emission of or irradiation with interfering signals.

Hermetic sealing can alternatively be realized by encapsulation in the substrate. The electronics or a component of the electronics can be arranged in or on a layer or stratum of the substrate. At least one further layer or stratum of the substrate can further advantageously be arranged above it for further encapsulation of the electronics or a component of the electronics. In other words, the electronics can be “buried” in a layer by further layers disposed above them. This provides a particularly secure hermetic sealing of the sensor, and in particular the electronics or a component of the electronics.

The metal housing or encapsulation can furthermore be used to achieve the high pressure tightness required for some applications, in which both high temperatures and high pressures prevail (e.g. deep drilling).

The displacement sensor according to the invention can operate inductively, via eddy current or capacitively, for example.

The displacement sensor according to the invention provides a compact, high temperature-suitable displacement sensor with directly connected or integrated electronics, in which a simple line can be used for connecting to supply and/or peripheral devices. High signal quality can be provided by a signal that has already been processed and amplified by the electronics of the displacement sensor. A possible application for the displacement sensor according to the invention is in particular the measurement of distance, position, displacement and vibration by means of the inductive, capacitive or eddy current measurement principle.

### BRIEF DESCRIPTION OF THE FIGURES

There are various ways to advantageously configure and further develop the teaching of the present invention. For this purpose, reference is made to the subordinate claims on the one hand and, on the other hand, to the following discussion of preferred design examples of the invention on the basis of the drawing. In connection with the discussion of preferred design examples of the invention on the basis of the drawing, generally preferred configurations and further developments of the teaching are discussed as well. In the drawing, the figures show:

FIG. 1 a displacement sensor according to a first design example according to the invention in a sectional illustration,

FIG. 2 a second design example according to the invention in a sectional illustration,

FIG. 3 a third design example according to the invention in a sectional illustration,

FIG. 4 a fourth design example according to the invention in a sectional illustration, and

FIG. 5 a block diagram of a fifth design example according to the invention.

### DETAILED DESCRIPTION OF VARIOUS EMBODIMENTS

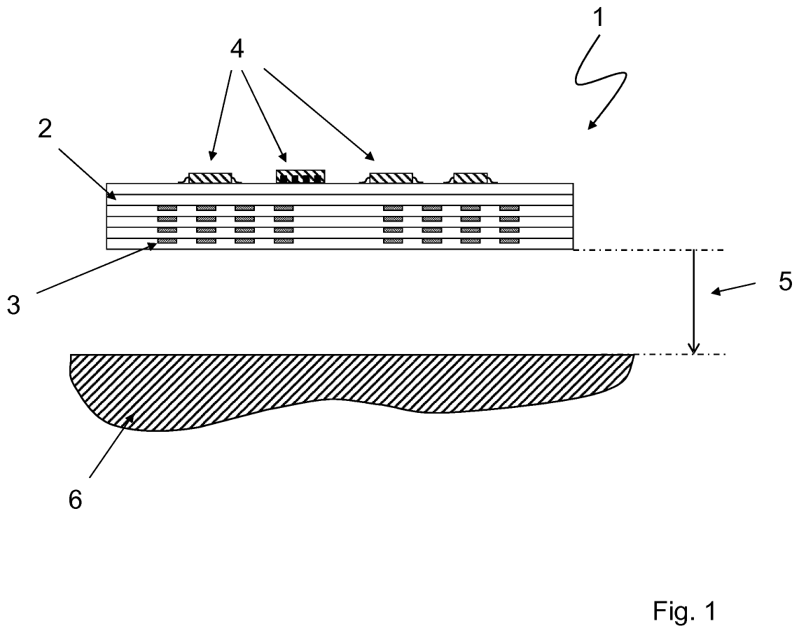

In a sectional illustration, FIG. 1 shows a first design example of a contactlessly operating displacement sensor according to the invention having a sensor element 1 designed for high temperatures and having a multilayer substrate 2 made of LTCC ceramic, whereby the displacement sensor here is an inductive or eddy current displacement sensor. Multilayer windings 3 of a coil of the sensor element 1 are embedded in the substrate 2. Electronics with electronic components 4 are disposed on the rear side of the substrate 2, wherein each electronic component 4 comprises a ceramic housing soldered to the substrate 2. The displacement sensor measures the distance 5 to a measurement object 6.

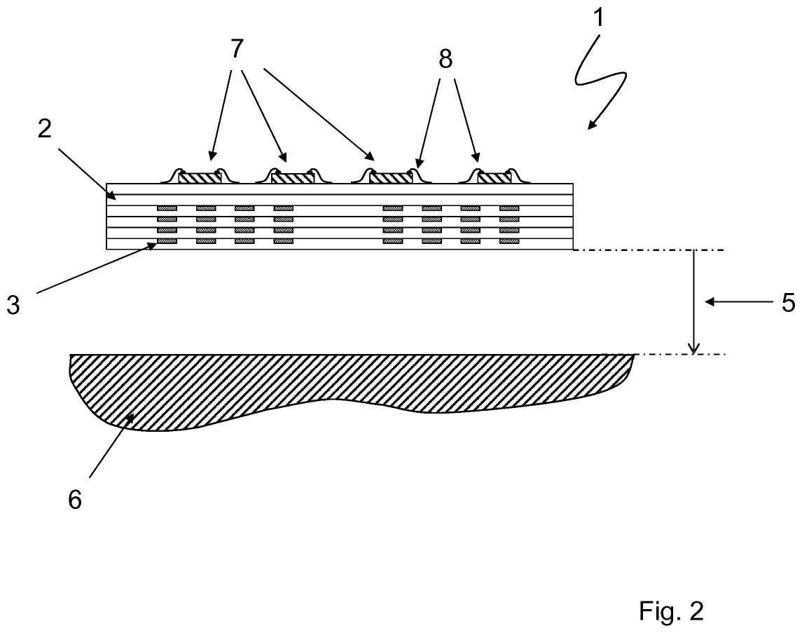

FIG. 2 shows a second design example of a contactlessly operating displacement sensor according to the invention in a sectional illustration, whereby this design example has essentially the same arrangement as the first design example according to FIG. 1. The electronic components do not have a ceramic housing, however, but are formed by semiconductor components, so-called electronic chips (dies) 7, which are bonded to bond pads of the substrate 2 by means of gold wire bonds 8.

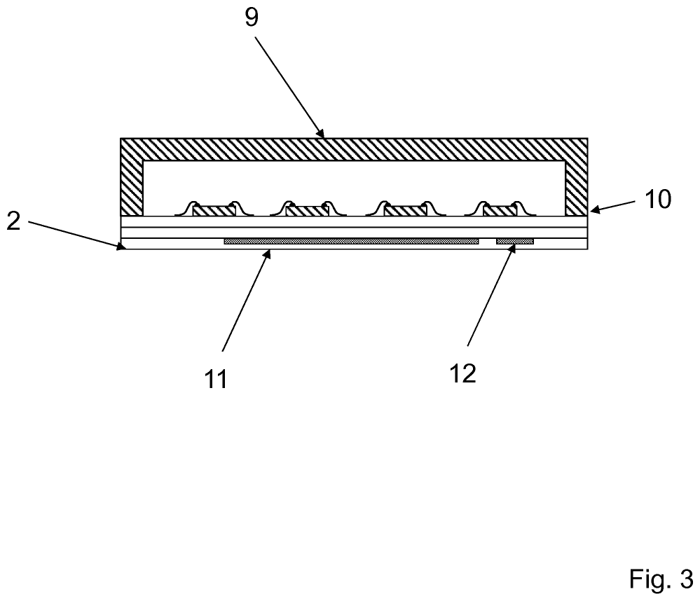

FIG. 3 shows a third design example of a contactlessly operating displacement sensor according to the invention in a sectional illustration, whereby the displacement sensor here is a capacitive displacement sensor for distance measurement having a metal housing 9, which is connected to the ceramic substrate 2 by active soldering. The active soldering produces a hermetically sealed solder connection 10. The capacitive displacement sensor contains a measurement electrode 11 and a concentric shield electrode 12, which are integrated in the substrate 2 and thus in the sensor element.

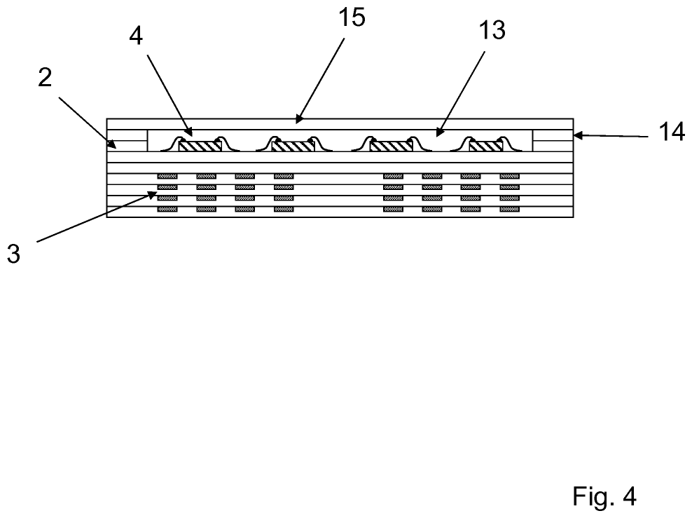

FIG. 4 shows a fourth design example of a contactlessly operating displacement sensor according to the invention, whereby this example of an eddy current displacement sensor shows a different type of hermetic sealing. The electronic components 4 are “buried” within the layers of the multilayer substrate 2. The electronic components 4 are disposed on one layer. This is accomplished by creating one or more hollow spaces 13 in the substrate 2. First, one layer is populated with electronic components 4. This is followed by further layers 14 with punched out free spaces, which are ultimately completely closed with one or more layers 15. After sintering, a hermetically sealed package of all layers with the sintered-in measuring element in the form of the coil 3 and the electronics consisting of the electronic components 4 is created.

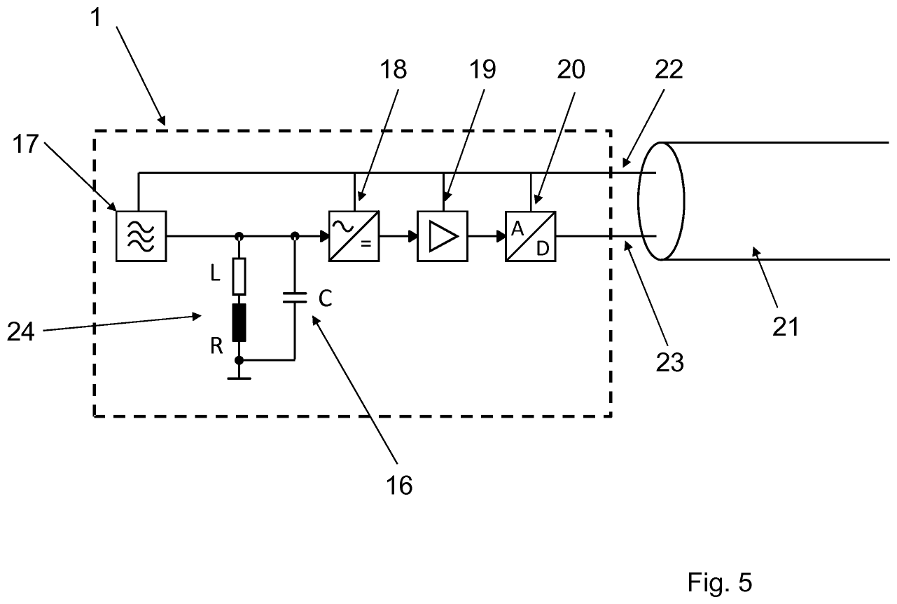

Using a block diagram, FIG. 5 shows a fifth design example of a contactlessly operating displacement sensor according to the invention, whereby the displacement sensor here is an eddy current displacement sensor. The sensor element 1 contains a coil 24 with an inductance L and a resistance R as the measuring element, whereby the coil 24 is supplemented with a capacitor C 16 to form a resonant circuit. The coil 24 is sintered into the substrate. The control electronics with the oscillator 17 and the evaluation electronics, which consists of a demodulator 18, a preamplifier 19 and an analog-to-digital converter 20 as functional assemblies, are disposed on the rear side of the substrate. A cable 21 connected to the electronics consists of 2×2 wires in a twisted-pair arrangement, whereby one pair of wires 22, as a supply line, provides the supply voltage and another pair of wires 23 transmits digitized signals.

In the manner according to the invention, it has been recognized that, even in the high temperature range above 125° C., it is possible to carry out an electrical coupling between the sensor element and the electronics without the familiar cables, via which the electronics can be separated from the sensor element that is exposed to the high temperatures in the usual way. Specifically, electronics designed for this high temperature range are connected directly to the sensor element or integrated into the sensor element. The high temperature-suitable electronics are mounted quasi directly on the sensor element without requiring the use of any type of cable connection for the electrical coupling between the sensor element and the electronics. This ensures a high degree of measurement reliability, because interference from the cable during the transmission of the determined very small and/or high-frequency signals can be avoided. The production is furthermore simplified considerably as well, because there is no need to use special cables that are difficult to handle, and there is also no need to provide a large installation space for complex cable contacting.

As a result, the displacement sensor according to the invention is a displacement sensor which allows reliable measurements in the high temperature range with constructionally simple means.

With respect to a particularly high suitability for the high temperature range, the electronics, or at least one component of the electronics, can be produced on the basis of SoI (silicon on insulator) technology or on the basis of GaAs, SiC or diamond as the semiconductor material. SoI technology is suitable up to working temperatures of about 300° C. GaAs, SiC or diamond as semiconductor materials are also suitable for working temperatures above 300° C.

The high temperature sensor elements used within the context of the invention, which are used to measure geometric variables such as distance, position, displacement, thickness or vibration and, on the basis of these applications, can be referred to as displacement sensor elements, are based on electromagnetic measurement principles, i.e. an inductive, capacitive or eddy-current based mode of operation. Because of these measurement principles, these sensor elements are particularly suitable for high temperature applications.

In a constructionally particularly simple manner, the sensor element can comprise a substrate with at least one embedded sensor component, such as the windings of a coil. At least one strip conductor which can be used for contacting the electronics is advantageously disposed on the substrate.

The substrate should itself be suitable for the high temperature range, whereby the substrate can advantageously comprise a circuit board, preferably made of polyimide, PTFE (polytetrafluoroethylene) or LCP (liquid crystal polymer), or a ceramic, preferably made of AL₂O₃, LTCC (low temperature co-fired ceramics) or HTCC (high temperature co-fired ceramics). Such high temperature circuit boards are suitable up to a temperature of about 300° C. For temperatures higher than that, substrates made of ceramic are particularly advantageous. In principle, it is possible to realize a ceramic sensor element for the high-frequency range.

The electronics of the displacement sensor can be mounted directly on the sensor element. High temperature-suitable methods can be used for the necessary assembly and connection techniques. The electronics can advantageously be disposed in a ceramic housing, for example, or comprise at least one component disposed in a ceramic housing. Components of the electronics or electronic modules can be disposed in a ceramic housing. Alternatively, the electronics can be connected to the sensor element as a chip on board or chip on ceramic or as a flip chip on a silicon carrier. Semiconductor components (dies) can be directly connected to the sensor element by means of aluminum or gold wire bonds with bond pads on a substrate. The strip conductors already mentioned above, which can be disposed directly on the substrate, can be used for this purpose. In the case of a circuit board as a substrate, copper strip conductors specifically can be used. For LTCC or HTCC technology, printed circuits or strip conductors can be used.

The control electronics can particularly advantageously comprise an oscillator. With such an oscillator, the frequency required for the operation of the displacement sensor can be generated on site at the sensor element. There is therefore no need to transmit a high-frequency control signal to the electronics from a remote position via a line. The oscillator can be a sine wave oscillator, for example, or a square wave oscillator, whereby such a square wave oscillator is particularly easy to realize.

The evaluation electronics can generally consist of a plurality of functional assemblies. As a functional assembly, the evaluation electronics can particularly preferably comprise only a demodulator for generating a rectified voltage or current signal. This represents a very simple design of the evaluation electronics. With such a configuration, there is no need to transmit a high-frequency signal via a connecting line that is susceptible to a variety of interference factors. The evaluation electronics can further advantageously additionally comprise a preamplifier, because in this case preamplified signals that are less susceptible to external interference can be transmitted at a higher level. As an alternative or in addition to such a preamplifier, the evaluation electronics can comprise an analog-to-digital converter with which determined signals can already be digitized, which makes signal transmission particularly immune to interference. As a further alternative or addition to a preamplifier and/or an analog-to-digital converter, the evaluation electronics can also comprise a microcontroller which already performs signal processing, e.g. linearization, filtering, etc. Particularly advantageous for configuring the evaluation electronics is that nowadays there are also microcontrollers for temperature ranges up to 200° C.

The components of the electronics can be produced in SoI or GaAs processes, for example.

The electronics can particularly advantageously consist of logic components or comprise logic components, e.g. XOR gates, because logic components are also available in a very inexpensive high temperature version. Very simple oscillator and demodulator circuits can thus be realized.

Since the electronics are connected directly to the sensor element or integrated into the sensor element, simple and inexpensive cables can be used for power supply and for data transmission from the displacement sensor to peripheral devices and vice versa, because no high-frequency signals or low-level signals have to be transmitted. A supply voltage suffices for the control. The electronics on or in the sensor element can provide an already demodulated signal, for which no special demands are placed on the line. Standard high temperature lines or steel sheathed cables can therefore be used for output and/or supply, e.g. with twisted lines. In the most simple case, one pair of wires (e.g. twisted pair) suffices, if the signal is modulated onto the supply line in digital form or is provided in analog form via a current interface. If the supply and signal lines are implemented separately, two pairs of wires, e.g. 2×2 twisted pair, suffice. These are less expensive and easier to handle than coaxial or triaxial lines. The connecting line can be guided through a housing and connected to the electronics in a known manner. For this purpose, the electronics can comprise a suitable cable connection.

Since chemical processes are accelerated at high temperatures, hermetic sealing of the displacement sensor or components of the displacement sensor is particularly advantageous. Specifically, the displacement sensor or the sensor element and/or the electronics can be hermetically sealed. There are two aspects to hermetic sealing: On the one hand, it prevents harmful substances from penetrating into the displacement sensor or the sensor element and/or the electronics and attacking the electronic components or the supply lines or contacts there. On the other hand, hermetic sealing prevents outgassing or leaking of substances that could cause contamination or damage at the installation location of the displacement sensor. Such hermetic sealing is necessary for certain applications, such as processing systems or astronautics.

It is particularly advantageous if a hollow space in the displacement sensor, the sensor element or the electronics is filled with a preferably dry inert gas or evacuated during hermetic sealing.

Hermetic sealing can be achieved in several different ways. Hermetic sealing can be achieved in a particularly simple manner with a housing, preferably a housing that is soldered to the substrate, in particularly all the way around, and is thus hermetically sealed to the substrate. A metal housing can be soldered hermetically to a ceramic substrate, for example, e.g. by active soldering or by laser welding with a metal ring previously soldered on by vacuum soldering. Such a metal housing advantageously provides shielding against the emission of or irradiation with interfering signals.

Hermetic sealing can alternatively be realized by encapsulation in the substrate. The electronics or a component of the electronics can be arranged in or on a layer or stratum of the substrate. At least one further layer or stratum of the substrate can further advantageously be arranged above it for further encapsulation of the electronics or a component of the electronics. In other words, the electronics can be “buried” in a layer by further layers disposed above them. This provides a particularly secure hermetic sealing of the sensor, and in particular the electronics or a component of the electronics.

The metal housing or encapsulation can furthermore be used to achieve the high pressure tightness required for some applications, in which both high temperatures and high pressures prevail (e.g. deep drilling).

The displacement sensor according to the invention can operate inductively, via eddy current or capacitively, for example.

The displacement sensor according to the invention provides a compact, high temperature-suitable displacement sensor with directly connected or integrated electronics, in which a simple line can be used for connecting to supply and/or peripheral devices. High signal quality can be provided by a signal that has already been processed and amplified by the electronics of the displacement sensor. A possible application for the displacement sensor according to the invention is in particular the measurement of distance, position, displacement and vibration by means of the inductive, capacitive or eddy current measurement principle.

Lastly, it must expressly be noted that the above described design examples of the displacement sensor according to the invention serve only to explain the claimed teaching, but do not limit said teaching to these design examples.

### LIST OF REFERENCE SIGNS

1 Sensor element

2 Multilayer substrate

3 Windings of a coil, coil

4 Electronic component

5 Distance sensor element—measurement object

6 Measurement object

7 Electronic chips (dies)

8 Gold wire bond

9 Metal housing

10 Solder connection, welded seam active solder

11 Measurement electrode

12 Shield electrode

13 Hollow space

14 Layers with punched out free spaces

15 Final layer

16 Capacitor

17 Oscillator

18 Demodulator

19 Preamplifier

20 AD converter

21 Cable

22 Pair of wires

23 Pair of wires

24 Coil

1-15. (canceled)

16. Contactlessly operating displacement sensor having a sensor element (1) which is suitable for high temperatures and electronics which are electrically coupled to the sensor element (1) and comprise control and/or evaluation electronics, wherein the electronics are designed for a temperature range above 125° C. and are directly connected to the sensor element (1) or integrated into the sensor element (1).

17. Displacement sensor according to claim 16, wherein electronics or at least one component (4) of the electronics are produced on the basis of SoI (silicon on insulator) technology or on the basis of GaAs, SiC or diamond as the semiconductor material.

18. Displacement sensor according to claim 16, wherein the sensor element (1) comprises a substrate (2) having at least one sensor component embedded therein, wherein preferably at least one strip conductor is disposed on the substrate (2).

19. Displacement sensor according to claim 18, wherein the substrate (2) comprises a circuit board.

20. Displacement sensor according to claim 19, wherein the circuit board is made of polyimide, PTFE or LCP.

21. Displacement sensor according to claim 18, wherein the substrate (2) comprises a ceramic.

22. Displacement sensor according to claim 21, wherein the ceramic is made of Al₂O₃, LTCC or HTCC.

23. Displacement sensor according to claim 16, wherein the electronics are disposed in a ceramic housing or comprise at least one component (4) disposed in a ceramic housing.

24. Displacement sensor according to claim 16, wherein the electronics are connected to the sensor element (1) via chip on board as chip on ceramic.

25. Displacement sensor according to claim 16, wherein the control electronics comprise an oscillator (17), preferably a sine or square wave oscillator.

26. Displacement sensor according to claim 16, wherein, as a functional assembly, the evaluation electronics comprises only a demodulator (18) for generating a rectified voltage or current signal, and preferably also a preamplifier (19) and/or an analog-to-digital converter (20) and/or a microcontroller.

27. Displacement sensor according to claim 16, wherein, as a functional assembly, the evaluation electronics comprises a demodulator (18) for generating a rectified voltage or current signal and/or a preamplifier (19) and/or an analog-to-digital converter (20) and/or a microcontroller.

28. Displacement sensor according to claim 16, wherein the electronics consist of logic components or comprise logic components.

29. Displacement sensor according to claim 16, wherein the connection of the electronics for their output and/or supply is realized via one pair of wires or two pairs of wires.

30. Displacement sensor according to claim 16, wherein the electronics comprise a cable connection.

31. Displacement sensor according to claim 16, wherein the sensor or the sensor element (1) and/or the electronics is or are hermetically sealed.

32. Displacement sensor according to claim 31, wherein the hermetic sealing is realized by a housing.

33. Displacement sensor according to claim 31, wherein the hermetic sealing is realized by a housing soldered to the substrate (2) or by an encapsulation in the substrate (2).

34. Displacement sensor according to claim 31, wherein the hermetic sealing is realized by either an arrangement of the electronics or a component (4) of the electronics in or on a layer or stratum of the substrate (2) or by at least one further layer (15) or stratum of the substrate (2) arranged above it.

35. Displacement sensor according to claim 16, wherein the displacement sensor operates inductively, via eddy current or capacitively.
